(19) United States
(12) Patent Application Publication
(10) Pub. No.: US 2011/0016270 A1
(43) Pub. Date: Jan. 20, 2011

(54) RAPID STARTUP COMPUTER SYSTEM AND METHOD

(75) Inventor: CHUN-TE YEH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/610,356

(22) Filed: Nov. 2, 2009

(30) Foreign Application Priority Data
Jul. 15, 2009 (CN) 200910304350.6

(51) Int. Cl. G06F 12/06

(52) U.S. Cl. 711/105; 711/E12.084

(57) ABSTRACT

A computer system includes a north bridge chipset, a south bridge chipset, a memory, and a rapid startup apparatus. The rapid startup apparatus includes a DRAM module to install application programs or operation system programs, a battery, a control chip to control data reading and writing for the DRAM module, a PCI-E interface, and a switch circuit. The application programs or the operation system programs are loaded into the memory via the PCI-E interface, the south bridge chipset, and the north bridge chipset in series. The switch circuit processes voltage of the battery or the PCI-E interface and supply power to the DRAM module.

### BACKGROUND

1. Technical Field

The present disclosure relates to electronic apparatuses and, particularly, to a computer system with a rapid startup apparatus, and a rapid startup method of the computer system.

2. Description of Related Art

Nowadays, computers have relatively fast processors, prodigious amount of memory and seemingly ever-expanding hard disk space. However, hard disk drives remain relatively slow or improvement in significant access time has not been seen in many years. Indeed, performance of the hard disk has not kept pace with the Moore's Law trend in space of the hard disk: the space of the hard disk has increased nearly 6,000 times over the past four decades, while the performance of the hard disk has increased only eight times.

When a personal computer is started up, an operation system (OS) and drivers including environment information such as application link information and desktop environment information in the hard disk are deployed to the memory. Because of the low performance of the hard disk, it takes a long time to start up the personal computer.

### BRIEF DESCRIPTION OF THE DRAWINGS

FIG. 1 is a block diagram of a first exemplary embodiment of a computer system, the computer system includes a rapid startup apparatus.

FIG. 2 is a block diagram of the rapid startup apparatus of FIG. 1.

FIG. 3 is a flowchart of a first exemplary embodiment of a rapid startup method of the computer system in FIG. 1.

FIG. 4 is a block diagram of a second exemplary embodiment of a computer system.

FIG. 5 is a flowchart of a second exemplary embodiment of a rapid startup method of the computer system in FIG. 4.

### DETAILED DESCRIPTION

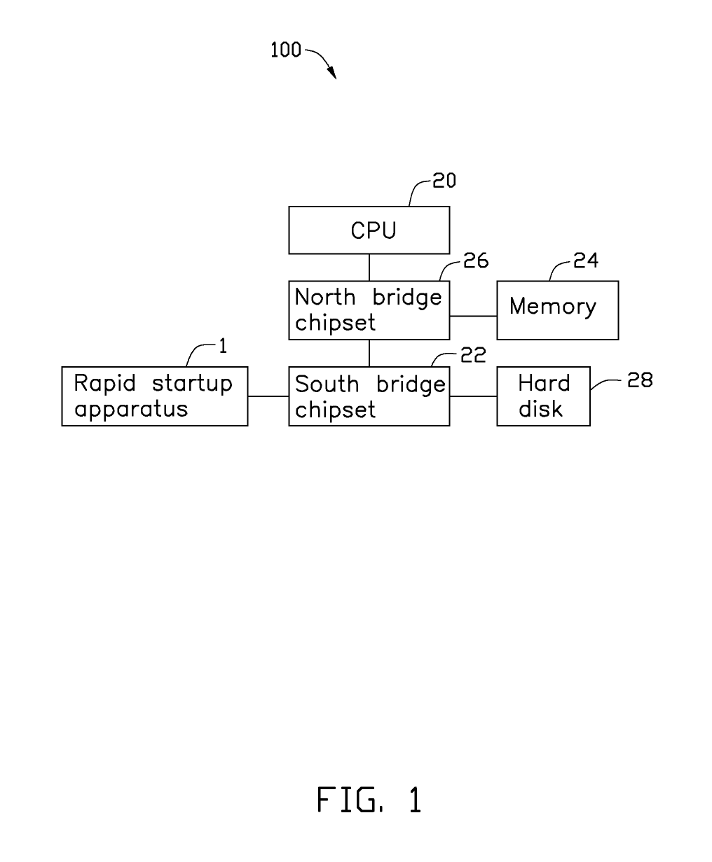

Referring to FIG. 1, a first embodiment of a computer system 100 includes a central processing unit (CPU) 20, a south bridge chipset 22, a memory 24, a north bridge chipset 26, a hard disk 28, and a rapid startup apparatus 1. The computer system 100 can run application softwares, such as Photoshop, or an operation systems (OS), such as Windows, Linux, or Mac quickly.

The north bridge chipset 26 is connected to the CPU 20 and the south bridge chipset 22. The south bridge chipset 22 is also connected to the hard disk 28 and the rapid startup apparatus 1. The OS is installed in the hard disk 28. The OS includes driver software. The drive software is to make the computer system 1 identify the rapid startup apparatus 1. It can be understood that the driver software is similar to universal serial bus (USB) driver software which make the computer system 100 identify an USB device.

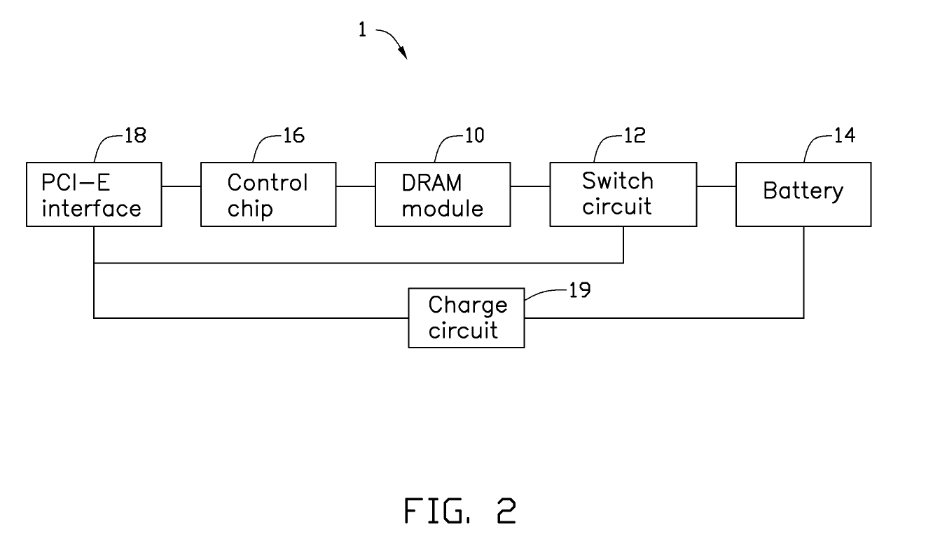

Referring to FIG. 2, the rapid startup apparatus 1 includes a dynamic random access memory (DRAM) module 10, a switch circuit 12, a battery 14, a control chip 16, and a peripheral component interconnect express (PCI-E) interface 18. The PCI-E interface 18, the control chip 16, the DRAM module 10, the switch circuit 12, and the battery 14 are connected in series. The switch circuit 12 is also connected to the PCI-E interface 18.

The switch circuit 12 is to process voltage of the battery 14 or the PCI-E interface 18, and supply power for the DRAM module 10. In the embodiment, the switch circuit 12 may be a logic switch. When the computer system 100 is power on, the switch circuit 12 processes voltage of the PCI-E interface 18, and supplies power for the DRAM module 10. When the computer system 100 is power off, the switch circuit 12 processes voltage of the battery 14, and supplies power for the DRAM module 10.

In other embodiments, the rapid startup apparatus 1 further includes a charge circuit 19. The charge circuit 19 is connected between the PCI-E interface 18 and the battery 14. When the computer system 1 is power on, the charge circuit 19 charges the battery 14.

The PCI-E interface 18 is also connected to the south bridge chipset 22. The PCI-E interface 18 transmits data, such as application software or OS, from the DRAM module 10 to the memory 24 via the south bridge chipset 22 and the north bridge chipset 26 in series. The control chip 16 controls the DRAM module 10. It can be understood that the control chip 16 is similar to a memory controller in the computer system which controls the memory 24.

After the computer system 100 finishes the startup process, the OS identifies the rapid startup apparatus 1 via the driver software. As a result, the rapid startup apparatus 1 functions as a hard disk.

After the computer system 100 identifies the rapid startup apparatus 1, application softwares, such as Photoshop, can be installed into the DRAM module 10 of the rapid startup apparatus 1. It can be understood that the DRAM module 10 has a same architecture as the double data rate synchronous dynamic random access memory (DDR SDRAM). More application softwares can be installed in the DRAM module 10 if the capability of the DRAM module 10 is large enough.

When the CPU 20 receives a command to execute the Photoshop program, the Photoshop program in the DRAM module 10 is loaded into the memory 24 via the south bridge chipset 22 and the north bridge chipset 26 in series. Because the speed of the CPU 20 reading data from the DRAM module 10 is faster than reading data from the hard disk 28 obviously, a time the Photoshop program be loaded into the memory 24 from the DRAM module 10 is less than a time the Photoshop program be loaded into the memory 24 from the hard disk 28. As a result, it takes less time to startup the Photoshop program.

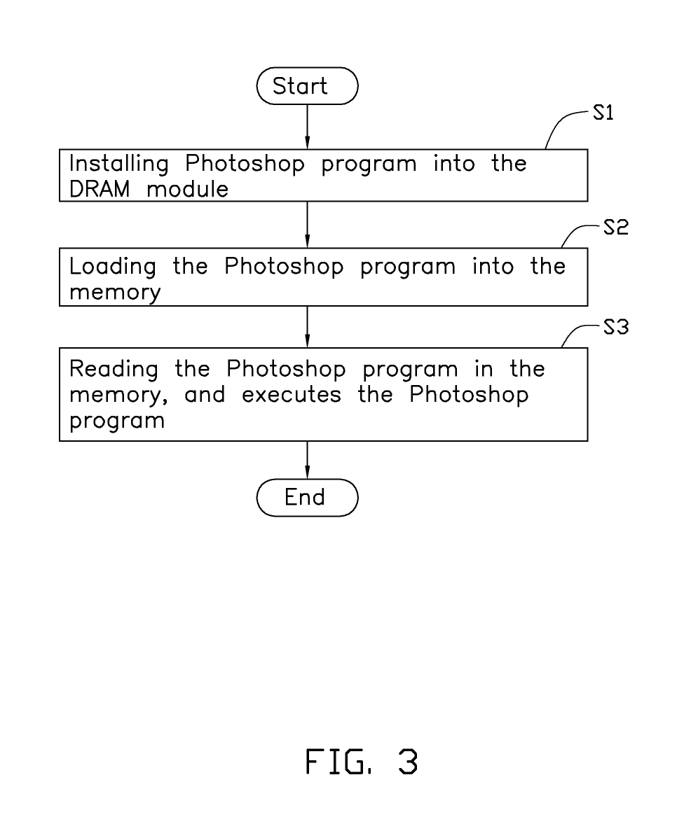

Referring to FIG. 3, a first embodiment of a startup method of the computer system 100 includes the following steps.

In step S1, application softwares, such as Photoshop, are installed into the DRAM module 10 of the rapid startup apparatus 1.

In step S2, the Photoshop program is loaded into the memory 24.

In step S3, the CPU 20 reads the Photoshop program in the memory 24, and executes the Photoshop program. As a result, the computer system 100 can startup the Photoshop program rapidly.

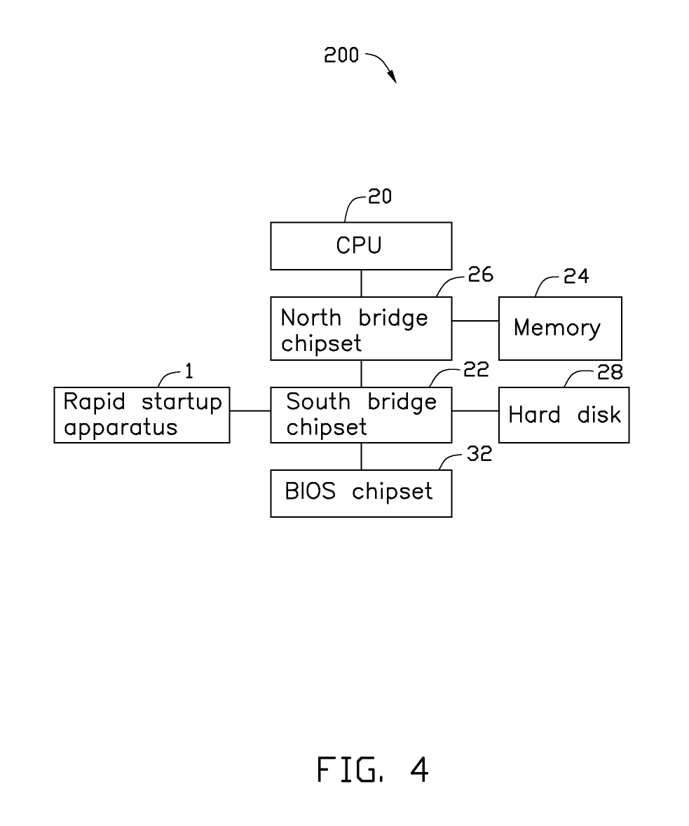

Referring to FIG. 4, a second embodiment of a computer system 200 includes the CPU 20, the south bridge chipset 22, the memory 24, the north bridge chipset 26, the hard disk 28, a basic input output system (BIOS) chipset 32, and the rapid startup apparatus 1.

In the embodiment, the BIOS chipset 32 can identify the DRAM module 10 via the control chip 16. Users can install the OS, such as Windows, into the DRAM module 10 of the rapid startup apparatus 1. It can be understood that the driver software must be loaded into the BIOS chipset 32 when the OS is installed into the DRAM module 10. As a result, the DRAM module 10 functions as a hard disk. The process of installing the OS into the DRAM module 10 is similar to the process of installing the OS into the hard disk 28.

After finished installing the OS into the DRAM module 10, users can set the DRAM module 10 as the first startup device in the BIOS interface. In this way, the computer system 100 will startup from the DRAM module 10 when the computer system 100 startups for the next time. The CPU 20 reads data of the OS from the DRAM module 10 via the north bridge chipset 26, the south bridge chipset 22, and the PCI-E interface 18 in series, and loads the data into the memory 24. After loading, the CPU 20 reads data of the OS from the memory 24 via the north bridge chipset 26, and executes the OS program to startup the computer system 100.

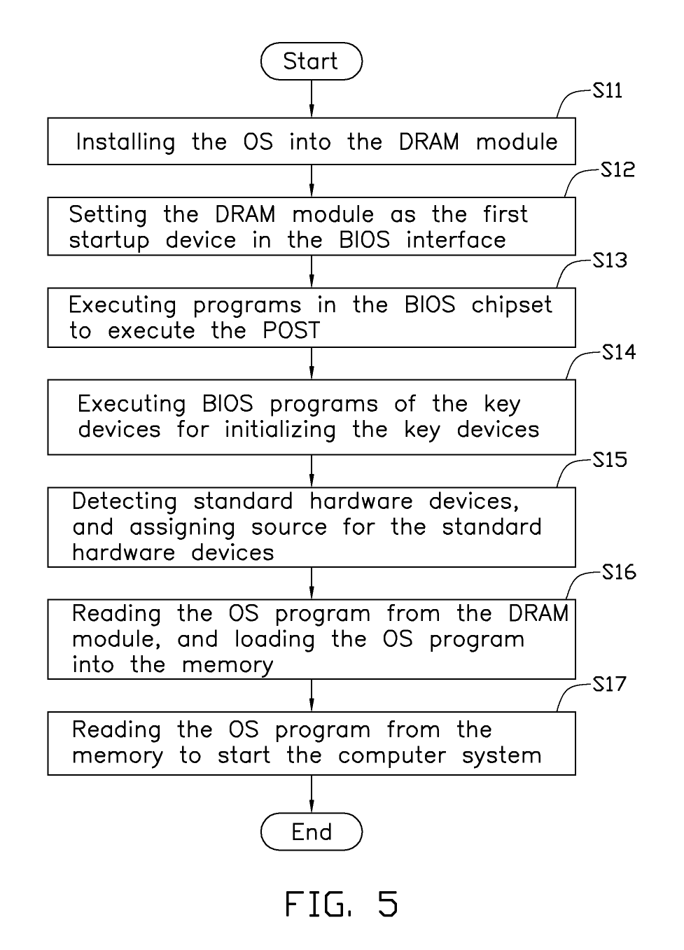

Referring to FIG. 5, a second embodiment of a startup method of the computer system 100 includes the following steps.

In step S11, the OS is installed into the DRAM module 10 of the rapid startup apparatus 1.

In step S12, the DRAM module 10 is set as the first startup device in the

BIOS interface.

In step S13, the CPU 20 executes programs in the BIOS chipset 32 to execute the power on self test (POST). It can be understood that the POST is executed for detecting key devices, such as memory 24 and a graphics card, in the computer system 100 to ensure whether the key devices are working normal.

In step S14, BIOS programs of the key devices are executed for initializing the key devices.

In step S15, the BIOS chipset 32 detects standard hardware devices, such as the hard disk 28, a CD-ROM, a keyboard, and assigns source, such as interrupt source, for the standard hardware devices.

In can be understood that the steps S13, S14, and S15 are universal processes for computer systems.

In step S16, the CPU 20 reads the OS program from the DRAM module 10 via the north bridge chipset 26, the south bridge chipset 22, and the PCI-E interface 18. The CPU 20 further loads the OS program into the memory 24.

In step S17, the CPU 20 reads the OS program from the memory 24 via the north bridge chipset 26, and initializes the OS program to start the computer system 100.

In a similar way, because the speed of the CPU 20 reading data from the DRAM module 10 is faster than reading data from the hard disk 28 obviously, a time the OS program be loaded into the memory 24 from the DRAM module 10 is less than a time the OS program be loaded into the memory 24 from the hard disk 28. As a result, it takes less time to startup the OS.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A computer system comprising:
a north bridge chipset;
a south bridge chipset;
a memory; and
a rapid apparatus comprising:
a dynamic random-access memory (DRAM) module to install application programs or operation system programs;
a battery;
a control chip to control data reading and writing for the DRAM module;
a peripheral component interconnect express (PCI-E) interface connected to the south bridge chipset, and the DRAM module via the control chip; wherein the application programs or the operation system programs are loaded into the memory via the PCI-E interface, the south bridge chipset, and the north bridge chipset in series; and
a switch circuit to process voltage of the battery or the PCI-E interface and supply power to the DRAM module.

2. The computer system of claim 1, further comprises a basic input output system (BIOS) chipset, wherein the BIOS chipset identifies the DRAM module via the control chip.

3. The computer system of claim 1, wherein the rapid startup apparatus further comprises a charge circuit, the charge circuit is connected between the PCI-E interface and the battery for charging the battery.

4. The computer system of claim 1, wherein the operation system programs comprise Windows, Linux, or Mac.

5. A startup method for a computer system, the computer system comprising a central processing unit (CPU), a north bridge chipset, a south bridge chipset, a memory, and a rapid startup apparatus; wherein the rapid startup apparatus comprises a DRAM module, a switch circuit, a battery, a control chip, and a PCI-E interface; the switch circuit is to process voltage from the battery or the PCI-E interface, and provide power to the DRAM module; the control chip is to control data reading and writing for the DRAM module; the PCI-E interface is connected to the north bridge chipset, and the DRAM module via the control chip; the startup method comprising:
installing application programs into the DRAM module;
loading the application programs into the memory; and
reading the application programs from the memory, and executing the application programs.

6. The startup method for the computer system of claim 5, wherein the computer system further comprises a charge circuit connected between the PIC-E interface and the battery, the charge circuit is to charge the battery.

7. A startup method for a computer system, the computer system comprising a central processing unit (CPU), a north bridge chipset, a south bridge chipset, a memory, a basic input output system (BIOS) chipset, and a rapid startup apparatus; wherein the rapid startup apparatus comprises a dynamic random-access memory (DRAM) module, a switch circuit, a battery, a control chip, and a peripheral component interconnect express (PCI-E) interface; the switch circuit is to process voltage from the battery or the PCI-E interface, and provide power to the DRAM module; the control chip is to control data reading and writing for the DRAM module; the PCI-E interface is connected to the north bridge chipset, and the DRAM module via the control chip; the BIOS chipset is to identify the DRAM module via the control chip; the startup method comprising:
installing operation system programs into the DRAM module;
setting the DRAM module as a first startup device in an BIOS interface;
executing programs stored in the BIOS chipset to execute POST;
executing BIOS programs of key devices to initialize the key devices;
detecting standard hardware devices in the computer system, and assigning source for the standard hardware devices;
loading operation system programs into the memory from the DRAM module; and
reading the operation system programs from the memory, and executing the operation system programs.

8. The startup method for the computer system of claim 7, wherein the computer system further comprises a charge circuit connected between the PIC-E interface and the battery, the charge circuit is to charge the battery.

9. The startup method for the computer system of claim 7, wherein the operation system is Windows, Linux, or Mac.
